(19) United States
(12) Patent Application Publication
(10) Pub. No.: US 2012/0219301 A1
(43) Pub. Date: Aug. 30, 2012

(54) LOW-LOSS, LOW-LATENCY, HOLLOW CORE FIBER COMMUNICATION SYSTEM

(76) Inventors: Karl William Koch, III, Elmira, NY (US); Sergey Yurevich Ten, Horseheads, NY (US); James Andrew West, Painted Post, NY (US)

(21) Appl. No.: 13/035,285

(22) Filed: Feb. 25, 2011

(51) Int. Cl. H04B 10/12

(52) U.S. Cl. 398/142

(57) ABSTRACT

An optical fiber communication system includes hollow core fiber coupled between a transmitter device and a receiver device. Both hollow core fiber and solid core fiber may be optically coupled between the transmitter and receiver devices, with the hollow core fiber preceding the solid core fiber. A Raman pump laser may be coupled to the solid core fiber to provide distributed Raman amplification in the solid core fiber. A plurality of series connected spans of hollow and solid core fiber may be employed. First and second transmission lines each having a hollow core fiber may be provided in a single cable.

### BACKGROUND

The present invention generally relates to fiber optic communication systems, and more particularly relates to a low-latency fiber based communication system that utilizes hollow core fiber.

Conventional fiber optic communications systems are widely employed to transfer data between remote locations. Conventional fiber optic cable typically includes a solid core single mode fiber (SMF) having a solid core material and a solid cladding surrounding the core. In conventional single mode fiber, the solid core is composed of glass and has a refractive index of about 1.45 to 1.48 depending on the level of doping and wavelength. Light travels in the solid core generally at a reduced speed as compared to light transmission in air or a vacuum, e.g., about 1.45 times slower than the speed of light in a vacuum. In a communication system, latency is the temporal delay experienced by a packet of information traveling from the transmitter to the receiver. The total latency is determined by propagation speed, packet size, routing, optical and electrical compensation of errors and impairments, storage delays and other optical and electrical delays in the system.

In more recent years, hollow core fiber which is based on the physics of photonic band-gaps has been developed and is generally also referred to as photonic band-gap fiber (PBGF). The hollow core fiber typically has a hollow core surrounded by a silica cladding containing a multitude of continuous air holes that form a periodic lattice structure. An alternative hollow core design uses high-index rods to form a photonic band-gap lattice in a glass matrix surrounding a hollow core. The hollow core fiber allows light to be guided in a low-index medium such as a gas, a mixture of gases or a vacuum, such that the group refractive index is slightly greater than unity and light velocity is typically around 0.9975 to 0.95 times the speed of light in a vacuum. Hollow core fiber typically results in reduced-latency, however, conventional hollow core fibers typically have higher losses and therefore require more optical power to be launched at the transmitter or at optical amplification points.

The need for lower-latency and reduced loss fiber optic based communication systems has arisen in several markets. For example, the financial trading markets are in need of a communication systems that allow decreased data transmissions times between trading computers. This will enable trading programs to complete programmed trading transactions more quickly. Accordingly, there is a need to provide low-latency fiber optic based communication to meet the needs of low-latency applications.

### SUMMARY

According to one embodiment, an optical fiber communication system is provided. The optical fiber communication system includes a transmitter device and a receiver device. The communication system also includes a hollow core fiber optically coupled to the transmitter device, wherein less than ten percent (10%) of the total length of solid core fiber in a span exists between the transmitter device and the hollow core fiber. The communication system further includes a solid core fiber operatively coupled between the hollow core fiber and the receiver device.

According to another embodiment, an optical fiber communication system is provided that includes a transmitter device, a receiver device and a hollow core fiber comprising a multi-mode portion of a length greater than 20 kilometers.

According to a further embodiment, an optical fiber communication system is provided that includes a transmitter device and a receiver device. The optical fiber communication system also includes a hollow core transmission fiber in optical communication with the transmitter device, and a solid core transmission fiber operatively coupled to the hollow core fiber. The communication system further includes a Raman pump laser coupled to the solid core transmission fiber for providing distributed Raman amplification in the solid core transmission fiber.

According to yet a further embodiment, an optical fiber communication system is provided that includes a transmitter device, a receiver device, and a plurality of serially connected spans. Each span includes a hollow core fiber and a solid core fiber operatively coupled to the hollow core fiber.

According to a further embodiment, a communication system is provided that includes a first transceiver, a second transceiver and a cable. The communication system also includes a first transmission line in the cable and operatively coupled between the first transceiver and the second transceiver. The communication system further includes a second transmission line in the cable and coupled between the second transceiver and the first transceiver. Each of the first and second transmission lines comprises a hollow core fiber.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a schematic diagram illustrating a communication system employing hollow core fiber and solid core fiber, according to a first embodiment;

FIG. 2 is a schematic diagram illustrating a communication system employing hollow core fiber and solid core fiber with Raman amplification, according to a second embodiment;

FIG. 3 is a schematic diagram illustrating a communication system employing a plurality of spans of hollow core fiber and solid core fiber, according to a third embodiment;

FIG. 4 is a bi-directional communication system employing multiple spans between two transceivers, according to a fourth embodiment;

FIG. 5 is a schematic diagram of two segments of a cable employed in a span of a communication system, according to one embodiment;

FIG. 6 is a schematic diagram of multiple segments of cable employed in a communication system, according to one embodiment; and

FIG. 7 is a cross-sectional view of a hollow core fiber that may be employed in the communication system, according to one embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

Various embodiments of an optical fiber communication system exhibiting low-latency, low-loss, and low-nonlinear penalties are provided that include a hollow core fiber coupled between a transmitter device and a receiver device. A hollow core fiber is defined as a fiber having a hollow core which provides a photonic band-gap and is also referred to herein as a photonic band-gap fiber. The hollow core has a low index medium which may include a gas, a mixture of gases, or a vacuum. In one embodiment, the hollow core is surrounded by a silica cladding containing a multitude of continuous air holes that form a periodic lattice structure as shown in FIG. 7. According to another embodiment, the hollow core fiber may use high-index rods to form a photonic band-gap lattice in a glass matrix surrounding a hollow core. At certain wavelengths, light is forbidden from penetrating into the lattice structures and thus is reflected, thereby forming a guided mode. The spectral bandwidth of the photonic band-gap guidance can be quite broad (e.g., 300-500 nm) and the center wavelength can be shifted by changing either the air-filling fraction or the pitch between the air holes. The hollow fiber may be a multi-mode fiber, according to one embodiment.

The communication system may also employ a solid core fiber connected in combination with the hollow core fiber between the transmitter device and the receiver device to form a hybrid fiber transmission path. The solid core fiber is defined as a fiber having a solid core made of a solid material, such as glass, that has a refractive index that is higher than the refractive index of the hollow core fiber. The solid core fiber may include single mode fiber. The total length of solid core fiber is the sum of all of the lengths of solid core fiber in a span between the transmitter device and the receiver device. In some embodiments, less than ten percent (10%) of the total length of solid core fiber in the span is present between the transmitter device and the first hollow core fiber. According to one embodiment, less than five percent (5%) of the total length of solid core fiber in the span is present between the transmitter device and the first hollow core fiber. According to a further embodiment, less than one percent (1%) of the total length of solid core fiber in the span is present between the transmitter device and the first hollow core fiber. According to yet another embodiment, zero percent (0%) or no solid core fiber is present between the transmitter device and the first hollow core fiber.

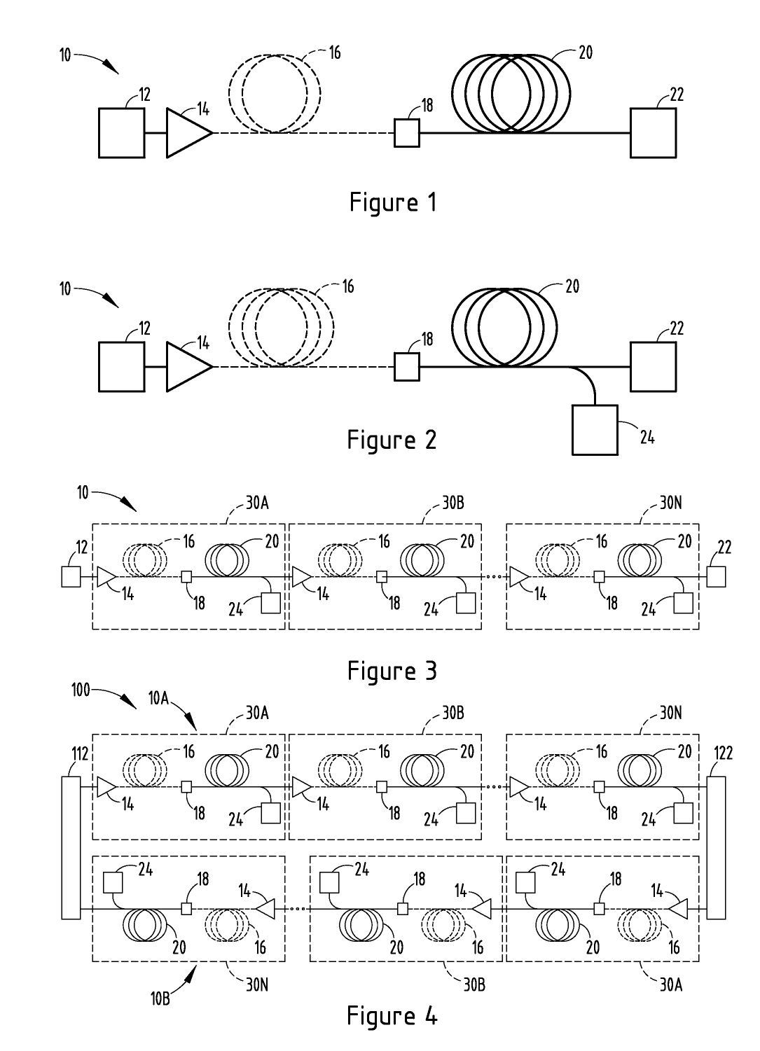

Referring to FIG. 1, a fiber optic communication system 10 is shown having an optical transmission path extending between a transmitter device 12 and a receiver device 22. The transmitter device 12 may be a first computer and the receiver device 22 may be a second computer. The first computer may transmit data via optical signals to the second computer, including financial market information, according to one embodiment. It should be appreciated that the first and second computers may each include a transceiver that serves both as a transmitter device and a receiver device for bi-directional data communication or may employ separate transmitter and receiver devices.

The communication system 10 shown in FIG. 1 employs a span of a first hollow core fiber 16 and a second solid core fiber 20 coupled in series between the transmitter device 12 and receiver device 22. The hollow core fiber 16 is in optical communication with the transmitter device 12 via an erbium doped fiber amplifier (EDFA) such that less than ten percent (10%) of the total length of solid core fiber exists between the transmitter device 12 and the hollow core fiber 16. The solid core fiber 20 is operatively coupled in series between the hollow core fiber 16 and the receiver device 22. The hollow core fiber 16 and solid core fiber 20 are connected together via a fiber connector 18 which may include a mechanical fiber splice. It should be appreciated that additional connecting components may be employed to couple the hollow fiber 16 and solid fiber 20 together and to the transmitter device 12 and receiver device 22. For solid core fiber and hollow core fiber connections, the connections may be made so as to reduce back reflections with either anti-reflection coatings which typically are good to about 20 dB, angle cleaves which are typically good greater than 60 dB or a combination of anti-reflection coatings and angle cleaves. It should be appreciated that a factory made hollow core fiber to a solid core fiber splice could be inserted in the field.

The hollow core fiber 16 may include a multi-mode fiber having a length greater than 20 kilometers, according to one embodiment. According to another embodiment, the hollow core multi-mode fiber has a length greater than 100 kilometers. According to one embodiment, the hollow core fiber 16 may include a single mode fiber. The solid core fiber 20 may include a single mode fiber, according to one embodiment. The solid core fiber 20 has a significant length such as 20 km to 50 km, according to one embodiment. While a single span of series connected hollow core fiber 16 and solid core fiber 20 is shown providing a single span in this embodiment, it should be appreciated that multiple series connected spans of hollow core fiber 16 and solid core fiber 20 may be employed between the transmitter device 12 and receiver device 22.

While the optical fiber communication system 10 is shown having a hollow core fiber 16 and a solid core fiber 20, according to one embodiment, it should be appreciated that the optical fiber communication system 10 may employ a hollow core fiber 16 absent any significant length of solid core fiber. In one embodiment, the optical fiber communication system may include a hollow core fiber 16 including a multi-mode portion of a length greater than 20 kilometers disposed between the transmitter device 12 and receiver device 22. According to another embodiment, the multi-mode portion of the hollow core fiber 16 may have a length greater than 100 kilometers. It should be appreciated that a solid core fiber may be coupled to the hollow core fiber and that the solid core fiber may be a single mode fiber, according to one embodiment.

Referring to FIG. 2, an optical fiber communication system 10 is shown having a hollow core transmission fiber 16 and a solid core transmission fiber 20 disposed between a transmitter device 12 and receiver device 22 as shown in the first embodiment with the addition of a Raman pump laser 24 coupled to the solid core transmission fiber 20. The Raman pump laser 24 provides distributed Raman amplification in the solid core transmission fiber 20. The distributed amplification provided in the solid core transmission fiber 20 by the Raman pump laser 24 provides added power to the communication system 10 to make up for losses that may be exhibited, particularly in the hollow core fiber 16. The Raman pump laser 24 may include pump lasers of multiple wavelengths to provide greater optical gain over a wider band of wavelengths. The solid core transmission fiber 20 is a transmission fiber which may have a length between 20 kilometers and 50 kilometers, according to one embodiment. The hollow core transmission fiber is a multi-mode hollow core fiber 16 and the solid core transmission fiber 20 includes a single mode fiber, according to one embodiment.

The hollow core fiber 16 preferably is the first fiber in a given span such that it precedes the solid core fiber 20 in a direction of data communication. The hollow core fiber 20 generally has no or little non-linearities, but exhibits higher losses as compared to the solid core fiber and therefore requires more power. By employing a multi-mode hollow core fiber, optical signal transmission is realized at a reduced signal loss due to the reduced attenuation. For long distance transmissions, a high launch power may be employed which may be achieved with the erbium doped fiber amplifier 14. In addition, the Raman distributed amplification provides additional power for the transmission over a long distance. It should be appreciated that a higher proportion of hollow core fiber 16 will result in a lower-latency, but will require more power to make up for the attenuation losses.

Referring to FIG. 3, an optical fiber communication system 10 is shown employing a plurality of series connected spans 30A-30N extending between the transmitter device 12 and the receiver device 22, according to one embodiment. Each span 30A-30N includes a hollow core fiber 16 and a solid core fiber 20 operatively coupled to the hollow core fiber 16. Each span 30A-30N may further include an erbium doped fiber amplifier 14, connector 18 and Raman laser pump 24, as described above. The series connection of adjacent spans 30A-30N is such that the output of the solid core fiber 20 of one span is connected to the input of the next span which is shown having the erbium doped fiber amplifier 14. The number of spans may vary depending on the length of transmission of the communication system 10. Each span 30A-30N may have a length of less than 70 kilometers, according to one embodiment.

The various embodiments as shown in FIGS. 1-3 provide optical signal communication from a transmitter device 12 to a receiver device 22. However, it should be appreciated that bi-directional communication may be achieved to communicate optical signals between two distinct devices.

Referring to FIG. 4, a bi-directional communication system 100 is illustrated for communicating data between a first transceiver 112 and a second transceiver 122. Each transceiver 112 and 122 may include a computer which is capable of both transmitting and receiving data. The first transceiver 112 may serve as a first transmitter device and a second receiver device, whereas the second transceiver 122 may serve as a first receiver device and a second transmitter device such that data is communicated from the first transmitter device to the first receiver device on one transmission line and from the second transmitter device to the first receiver device on a distinct second transmission line. The communication system 100 includes a first transmission path or line 10A for transmitting data from the first transceiver 112 to the second transceiver 122, and a second transmission path or line 10B for transmitting data from the second transceiver 122 to the first transceiver 112. Each transmission line includes one or more spans 30A-30N, each span having a hollow core fiber 16. In addition, each span may include a solid core fiber 20 connected to the hollow core fiber 16 via connector 18. Each span may further have an erbium doped fiber amplifier 14 and Raman pump laser 24 as described herein. Multiple spans 30A-30N are shown making up each transmission line 10A and 10B, however, it should be appreciated that one or more spans may be employed in each transmission line.

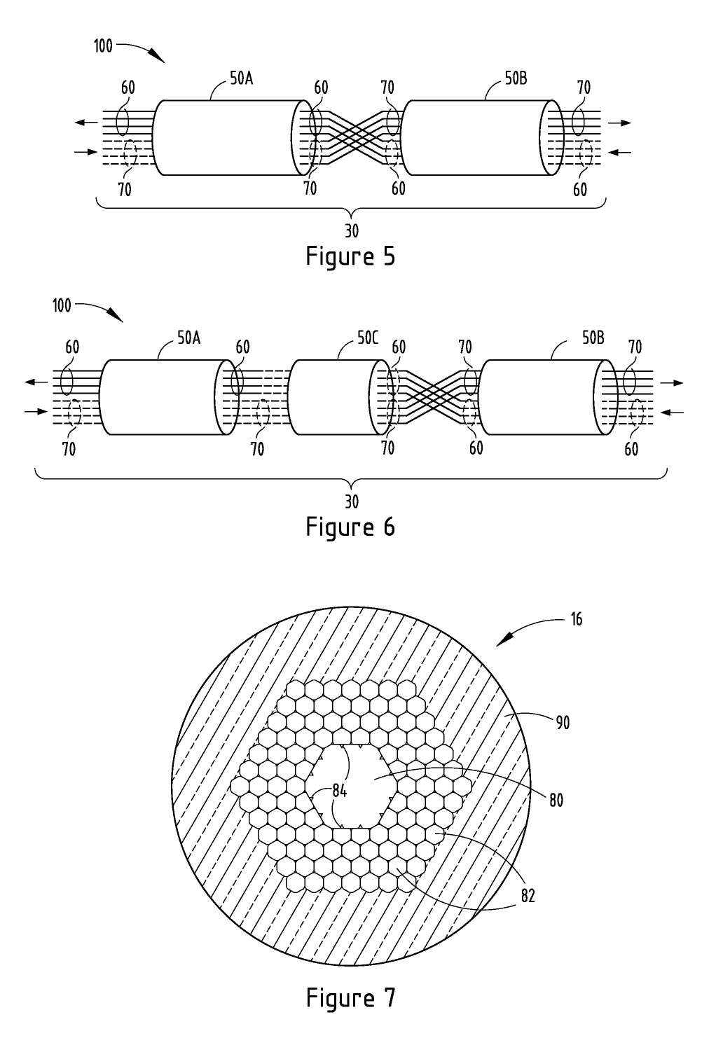

Referring to FIG. 5, first and second transmission lines 60 and 70 are shown provided in a single cable made up of cable segments 50A and 50B. Cable segment 50A includes first transmission line 60 having a hollow core fiber shown by solid lines and second transmission line 70 having a hollow core fiber shown by dashed lines provided therein. Cable segment 50B likewise includes first transmission line 60 having a hollow core fiber shown by dashed lines and second transmission line 70 having a solid core fiber shown by solid lines provided therein. The cable portions 50A and 50B are connected together such that the first transmission line and its solid core fiber within cable portion 50A is aligned and coupled to the first transmission line and its hollow core fiber within cable portion 50B to complete the first transmission line 60 from one end of the cable to the other end of the cable. Similarly, the second transmission line 70 and its hollow core fiber within first cable portion 50A is connected and coupled to the second transmission line 70 and its solid core fiber within second cable portion 50B to complete the second return transmission line 70 between the opposite ends of the cable. As a result, a cable is provided which houses both the hollow core fiber and solid core fiber to provide bi-directional communication between first and second transceivers such that optical signals pass through a hollow core fiber and a solid core fiber in one direction along a first transmission path 60 and travel through a hollow core fiber and solid core fiber in a distinct second transmission path 70.

Referring to FIG. 6, another embodiment of a cable employing both the first and second transmission paths or lines 60 and 70 is shown including a third intermediate cable portion 50C shown coupled between cable portions 50A and 50B. The third cable portion 50C includes fiber segments of the first and second transmission paths that provides bi-directional data transmission. Specifically, the third cable portion 50C may include hollow core fiber in both paths 60 and 70 that extends the overall length of each of transmission lines 60 and 70 so as to increase the amount of hollow core fiber in each transmission line. Alternately, the third intermediate cable portion 50C may employ fiber segments of solid core fiber to increase the overall effective length of solid core fiber in both transmission paths 60 and 70. It should be appreciated that the desired proportion of hollow core fiber to solid core fiber in a given transmission line may be provided by providing one or more intermediate cable portions. Further, it should be appreciated that the additional cable portions may be located between the first and second cable portions 50A and 50B or may be located prior to cable portion 50A or after cable portion 50C, according to other conceivable embodiments.

The hollow core fiber preferably precedes the solid core fiber in some embodiments since it has substantially zero non-linear impairment and thus can be used with high launch powers. By the time the optical signal reaches the solid core fiber, the hollow core fiber attenuation may have decreased the power to a point where further non-linear impairment should be very small. Although the latency of the transmission will be increased due to the solid core fiber, the total span attenuation will be significantly reduced with the hybrid hollow core fiber and solid core fiber embodiments. According to one example, a span having 40 kilometers of hollow core fiber may have an attenuation drop of about 40 dB, whereas a hybrid span having 50% half hollow core and 50% half solid core fibers may achieve an attenuation drop of about 24 dB. The average latency will be improved while achieving a more controlled attenuation drop by employing the hybrid fiber communication system 10.

It should be appreciated that the proportion of hollow core fiber to solid core fiber may vary depending upon the desired latency and acceptable losses, desired bit rate and bit error rate. In one embodiment, each span employs equal lengths of hollow core fiber and solid core fiber. According to other embodiments, a greater distance of hollow core fiber allows for a greater reduction in latency. It should further be appreciated that launch power required to maintain the signal strength may vary depending upon the length of the transmission and the amount of hollow core fiber as compared to solid core fiber. The launch power required can be calculated based on known characteristics of the fibers employed and the length of transmission paths.

Referring to FIG. 7, one example of a hollow fiber 16 is illustrated. The hollow fiber 16 shown is a multi-mode fiber having a core with a plurality of air holes 82 and a hollow core 80. In the example shown, the hollow core fiber 16 has a deformed 19-hole defect with retaining fingers 82. The hollow core 18 is surrounded by a glass cladding layer 90. The exemplary hollow core fiber 16 may include a 5 micrometer pitch for transmitting light near 1550 nm. Optical signals are refracted through the hollow core 18 at a high speed approaching the speed of light in a vacuum. It should be appreciated that other hollow core fibers may be employed in connection with the communication system 10 or 100.

The optical fiber communication system 10 or 100 may be employed to communicate data between first and second computers. According to one embodiment, the communication system 10 or 100 may interconnect computers that are used for financial transactions, particularly those that extend a long distance from one city to another. It should be appreciated that the communication system 10 or 100 may be employed in other applications to transmit optical signals between remote locations. The communication system 10 or 100 advantageously reduces the transmission time to transmit data between the transmitter and receiver devices with a managed signal low and without exceptional non-linear penalties to achieve a low-latency communication system. The communication system 10 and 100 advantageously overcomes high attenuation problems associated with the hollow core fiber, according to various embodiments.

It will be apparent to those skilled in the art that various modifications and variations can be made without departing from the spirit or scope of the claims.

What is claimed is:

1. An optical fiber communication system comprising:
a transmitter device;
a receiver device;
a hollow core fiber optically coupled to the transmitter device, wherein less than 10% of the total length of solid core fiber exists between the transmitter device and the hollow core fiber; and
a solid core fiber operatively coupled between the hollow core fiber and the receiver device.

2. The communication system of claim 1, wherein the hollow core fiber comprises a multi-mode hollow core fiber and the solid core fiber comprises a single mode fiber.

3. The communication system of claim 2, wherein the hollow core fiber has a length greater than 20 kilometers.

4. The communication system of claim 2, wherein the hollow core fiber has a length greater than 100 kilometers.

5. The communication system of claim 1, wherein less than 5% of the total length of solid core fiber exists between the transmitter device and the hollow core fiber.

6. The communication system of claim 1, wherein less than 1% of the total length of solid core fiber exists between the transmitter device and the hollow core fiber.

7. The communication system of claim 1, wherein the hollow core fiber is coupled to the transmitter device such that no solid core fiber exists between the transmitter device and the hollow core fiber.

8. The communication system of claim 1, wherein the transmitter device comprises a first computer and the receive device comprises a second computer, wherein the first computer transmits financial market information to the second computer.

9. An optical fiber communication system comprising:
a transmitter device;
a receiver device; and
a hollow core fiber comprising a multi-mode portion of a length greater than 20 kilometers.

10. The communication system of claim 9, wherein the multi-mode portion has a length greater than 100 kilometers.

11. The communication system of claim 9 further comprising a solid core fiber operatively coupled to the hollow core fiber, wherein the solid core fiber is a single mode fiber.

12. The communication system of claim 11, wherein the hollow core fiber is operatively coupled to the transmitter device and the solid core fiber is connected between the hollow core fiber and the receiver device.

13. The communication system of claim 9, wherein the transmitter device comprises a first computer and the receiver device comprises a second computer, wherein the first computer communicates financial market information to the second computer.

14. An optical fiber communication system comprising:
a transmitter device;
a receiver device;
a hollow core transmission fiber in optical communication with the transmitter device;
a solid core transmission fiber operatively coupled to the hollow core fiber; and
a Raman pump laser coupled to the solid core transmission fiber for providing distributed Raman amplification in the solid core transmission fiber.

15. The communication system of claim 14, wherein the solid core transmission fiber has a length between 20 kilometers and 50 kilometers.

16. The communication system of claim 14, wherein the hollow core transmission fiber comprises a multi-mode hollow core fiber and the solid core transmission fiber comprises a single mode fiber.

17. An optical fiber communication system comprising:
a transmitter device;
a receiver device;
a plurality of series connected spans, each span comprising:
a hollow core fiber; and
a solid core fiber operatively coupled to the hollow core fiber.

18. The communication system of claim 17, wherein each span has a length of less than 70 kilometers.

19. The communication system of claim 17, wherein each span further comprises a Raman pump laser amplifier coupled to the solid core fiber for providing distributed amplification in the solid core fiber.

20. The communication system of claim 17, wherein the hollow core fiber comprises a multi-mode hollow core fiber and the solid core fiber comprises a single mode fiber.

21. A communication system comprising:
a first transceiver;
a second transceiver;
a cable;
a first transmission line in the cable and operatively coupled between the first transceiver and the second transceiver; and
a second transmission line in the cable and coupled between the second transceiver and the first transceiver, wherein each of the first and second transmission lines comprises a hollow core fiber.

22. The communication system of claim 21, wherein each transmission line further comprises a solid core fiber operatively coupled to the hollow core fiber.

23. The communication system of claim 22, wherein the solid core fiber and the hollow core fiber are provided together within the cable.

24. The communication system of claim 21, wherein the first and second transmission lines comprise a plurality of spans, wherein each span comprises a hollow core fiber and a solid core fiber.

25. The communication system of claim 21, wherein the hollow core fiber precedes the solid core fiber in a direction of data communication.
